(19) United States
(12) Patent Application Publication
(10) Pub. No.: US 2025/0008482 A1
(43) Pub. Date: Jan. 2, 2025

(54) ENVIRONMENT CONSIDERATIONS FOR VEHICLE-TO-EVERYTHING (V2X) SIDELINK POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/710,274

(22) PCT Filed: Nov. 8, 2022
(86) PCT No.: PCT/US2022/079435

§ 371 Date: May 15, 2024

(30) Foreign Application Priority Data
Dec. 3, 2021 (GR) 20210100842

(51) Int. Cl. H04W 64/00; G01S 5/00; G01S 5/02; H04W 4/029; H04W 4/40

(52) U.S. Cl. CPC H04W 64/006; G01S 5/01; G01S 5/0236; H04W 4/029; H04W 4/40

(57) ABSTRACT

Disclosed are techniques for wireless communication. In an aspect, a first user equipment (UE) in a sidelink positioning group receives at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE, and performs a sidelink-related positioning operation based on the one or more environment parameters.

### CROSS-REFERENCE TO RELATED APPLICATIONS

The present application for patent claims the benefit of GR Application No. 20210100842, entitled “ENVIRONMENT CONSIDERATIONS FOR VEHICLE-TO-EVERYTHING (V2X) SIDELINK POSITIONING”, filed Dec. 3, 2021, and is a national stage application, filed under 35 U.S.C. § 371, of International Patent Application No. PCT/US2022/079435, entitled, “ENVIRONMENT CONSIDERATIONS FOR VEHICLE-TO-EVERYTHING (V2X) SIDELINK POSITIONING”, filed Nov. 8, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data. Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first user equipment (UE) in a sidelink positioning group includes receiving at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and performing a sidelink-related positioning operation based on the one or more environment parameters.

In an aspect, a method of wireless communication performed by a network node includes determining one or more environment parameters for at least a first UE of a plurality of UEs in a sidelink positioning group, wherein the one or more environment parameters indicate environmental properties associated with the first UE; and transmitting at least one positioning assistance information message to at least a second UE of the plurality of UEs, the at least one positioning assistance information message including at least the one or more environment parameters.

In an aspect, a first user equipment (UE) includes a memory; at least one transceiver; and at least one processor communicatively coupled to the memory and the at least one transceiver, the at least one processor configured to: receive, via the at least one transceiver, at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and perform a sidelink-related positioning operation based on the one or more environment parameters.

In an aspect, a network node includes a memory, at least one transceiver; and at least one processor communicatively coupled to the memory and the at least one transceiver, the at least one processor configured to: determine one or more environment parameters for at least a first UE of a plurality of UEs in a sidelink positioning group, wherein the one or more environment parameters indicate environmental properties associated with the first UE; and transmit, via the at least one transceiver, at least one positioning assistance information message to at least a second UE of the plurality of UEs, the at least one positioning assistance information message including at least the one or more environment parameters.

In an aspect, a first user equipment (UE) includes means for receiving at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and means for performing a sidelink-related positioning operation based on the one or more environment parameters.

In an aspect, a network node includes means for determining one or more environment parameters for at least a first UE of a plurality of UEs in a sidelink positioning group, wherein the one or more environment parameters indicate environmental properties associated with the first UE; and means for transmitting at least one positioning assistance information message to at least a second UE of the plurality of UEs, the at least one positioning assistance information message including at least the one or more environment parameters.

In an aspect, a non-transitory computer-readable medium stores computer-executable instructions that, when executed by a first user equipment (UE), cause the UE to: receive at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and perform a sidelink-related positioning operation based on the one or more environment parameters.

In an aspect, a non-transitory computer-readable medium stores computer-executable instructions that, when executed by a network node, cause the network node to: determine one or more environment parameters for at least a first UE of a plurality of UEs in a sidelink positioning group, wherein the one or more environment parameters indicate environmental properties associated with the first UE; and transmit at least one positioning assistance information message to at least a second UE of the plurality of UEs, the at least one positioning assistance information message including at least the one or more environment parameters.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4A is a diagram illustrating an example frame structure, according to aspects of the disclosure.

FIGS. 4B and 4C are diagrams of example sidelink slot structures with and without feedback resources, according to aspects of the disclosure.

FIG. 5 illustrates examples of various positioning methods supported in New Radio (NR), according to aspects of the disclosure.

FIG. 6 illustrates an example Long-Term Evolution (LTE) positioning protocol (LPP) call flow between a UE and a location server for performing positioning operations.

FIGS. 7A and 7B illustrate various scenarios of interest for sidelink-only or joint Uu and sidelink positioning, according to aspects of the disclosure.

FIG. 8 is a diagram illustrating an example resource pool for positioning within a sidelink resource pool, according to aspects of the disclosure.

FIG. 9 illustrates existing LPP information elements (IEs) that can be used to provide information about a UE's environment, according to aspects of the disclosure.

FIGS. 10 and 11 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station.” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

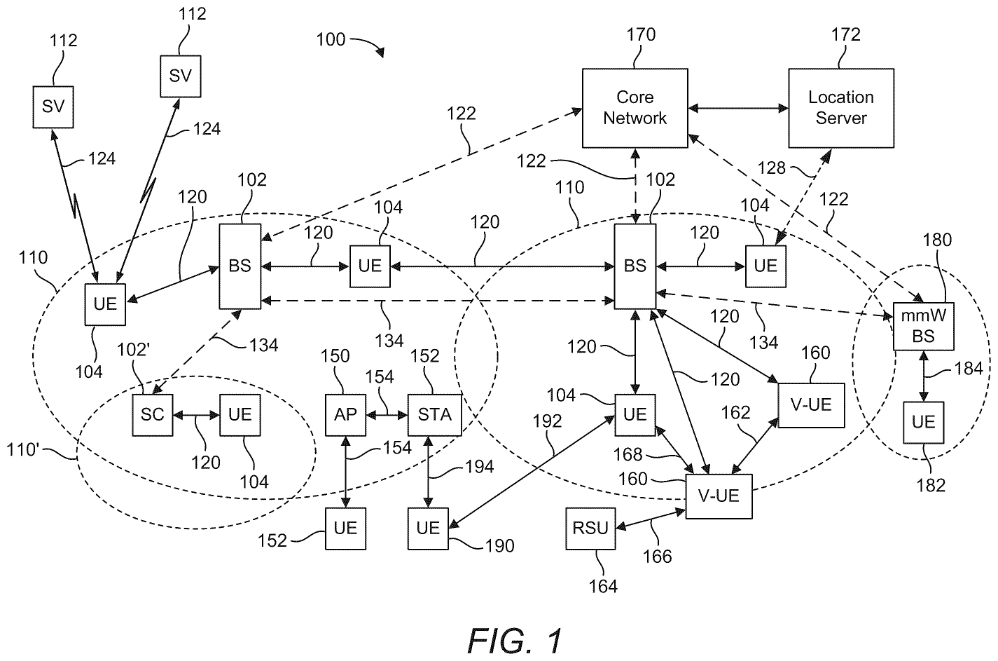

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace. RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of abase station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

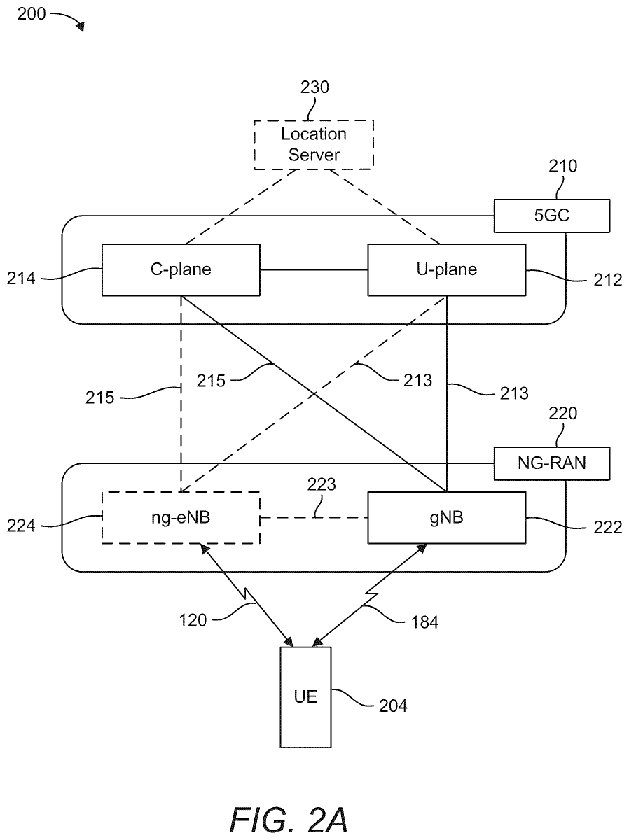

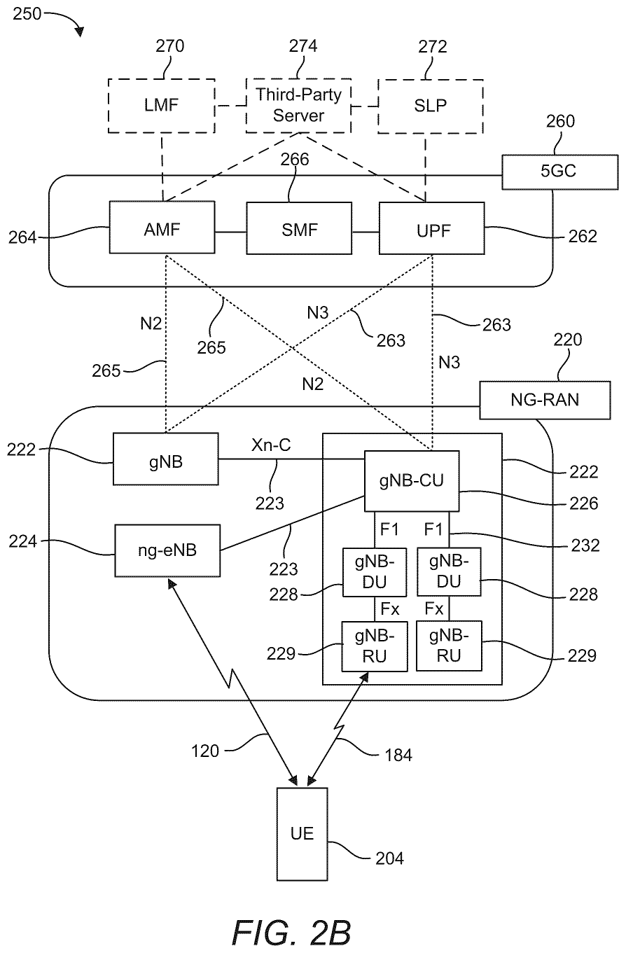

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management. UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the NII interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

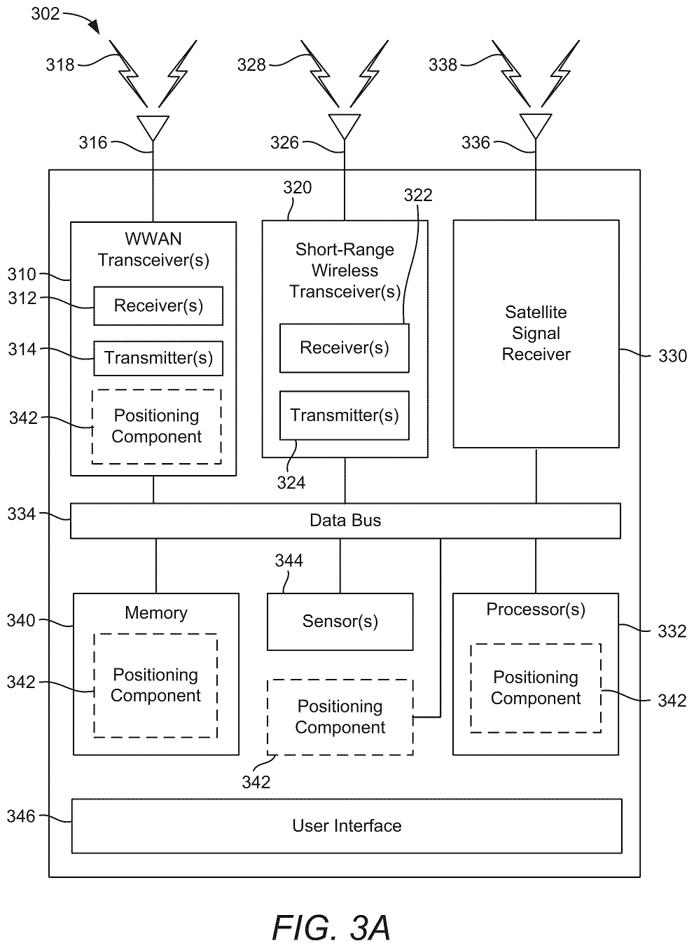

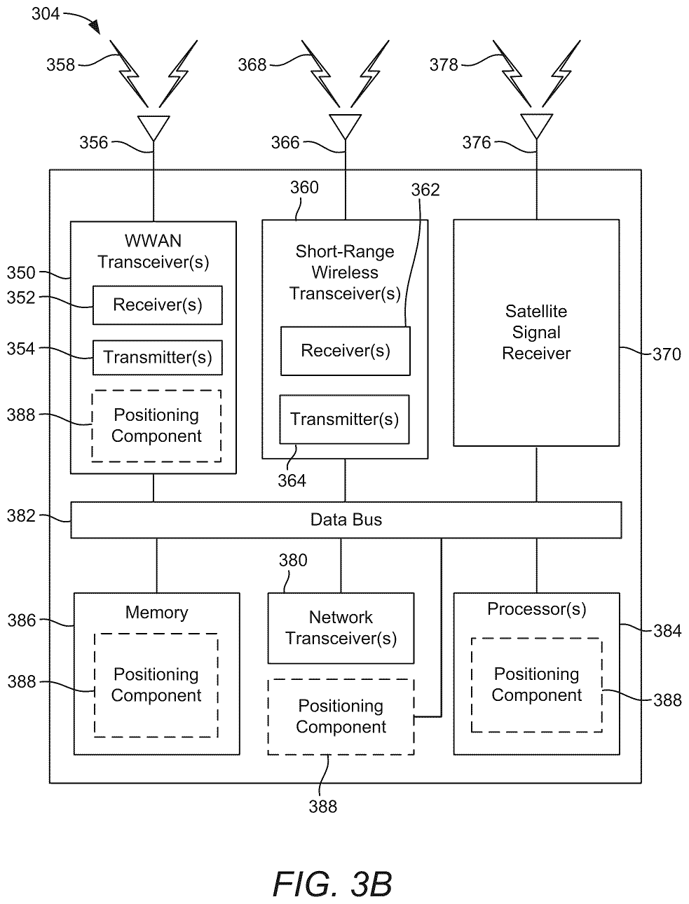

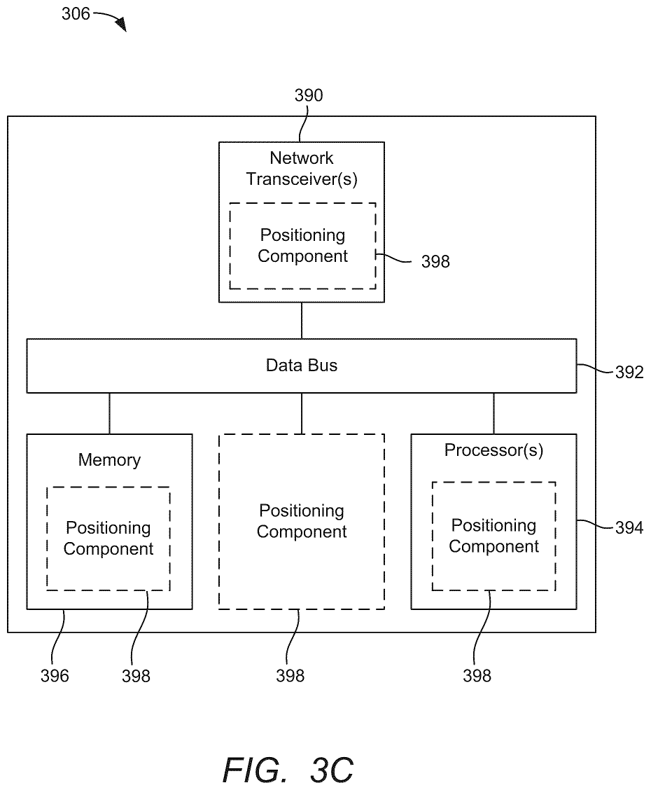

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR. LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals. Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

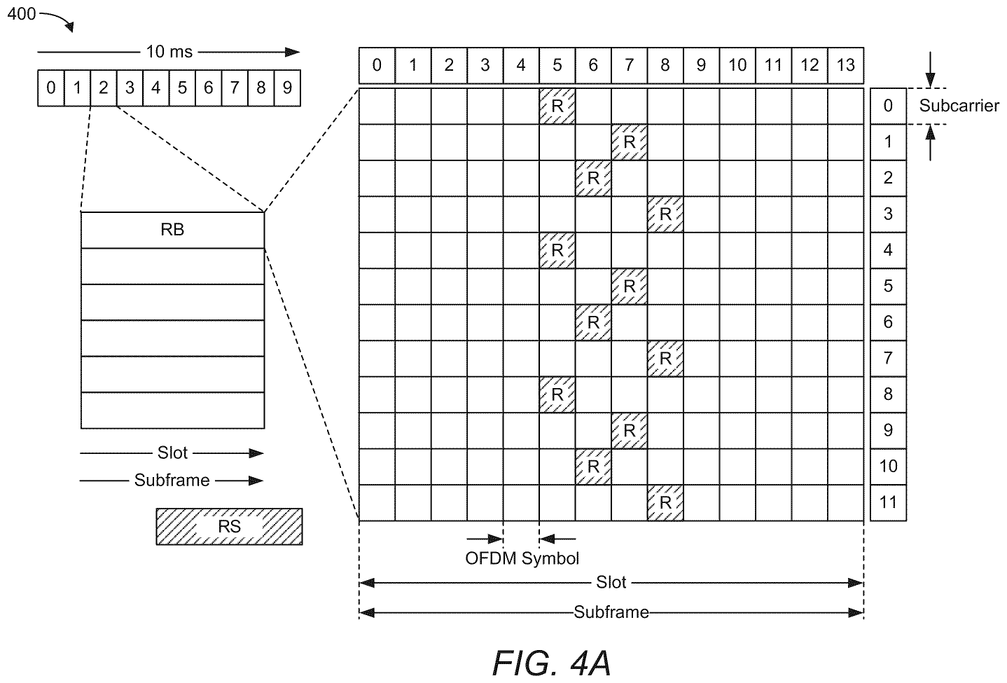

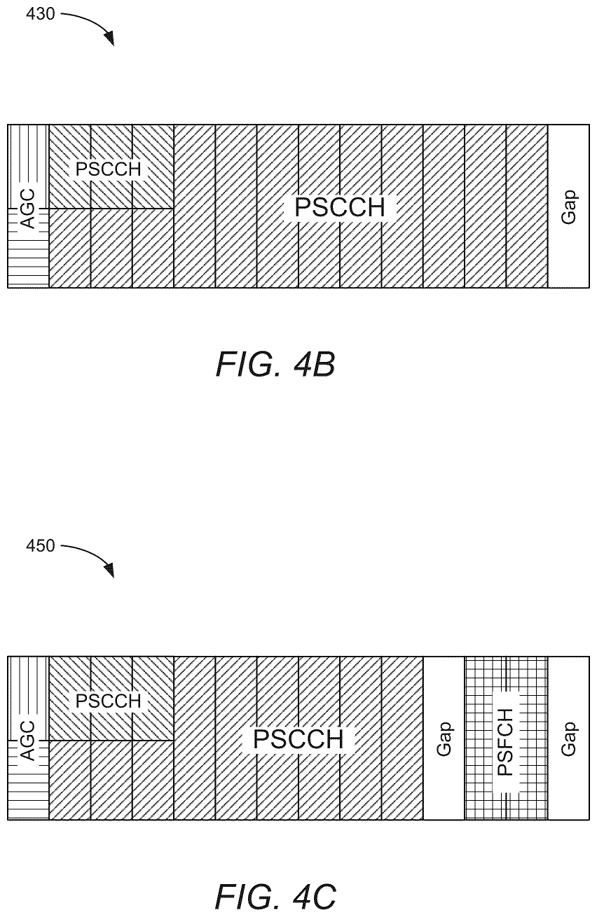

Various frame structures may be used to support downlink and uplink transmissions between network nodes (e.g., base stations and UEs). FIG. 4A is a diagram 400 illustrating an example frame structure, according to aspects of the disclosure. The frame structure may be a downlink or uplink frame structure. Other wireless communications technologies may have different frame structures and/or different channels.

LTE, and in some cases NR utilizes OFDM on the downlink and single-carrier frequency division multiplexing (SC-FDM) on the uplink. Unlike LTE, however. NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4A, a numerology of 15 kHz is used. Thus, in the time domain, a 10 ms frame is divided into 10 equally sized subframes of 1 ms each, and each subframe includes one time slot. In FIG. 4A, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4A, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4A illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4A illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: (0, 1, 0, 1); 6-symbol comb-2: {0, 1, 0, 1, 0, 1}; 12-symbol comb-2: {0, 1, 0, 1, 0, 1, 0, 1, 0, 1, 0, 1}, 4-symbol comb-4: {0, 2, 1, 3} (as in the example of FIG. 4A); 12-symbol comb-4: {0, 2, 1, 3, 0, 2, 1, 3, 0, 2, 1, 3}: 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource.” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition.” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS.” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre)configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

NR sidelinks support hybrid automatic repeat request (HARQ) retransmission. FIG. 4B is a diagram 430 of an example slot structure without feedback resources, according to aspects of the disclosure. In the example of FIG. 4B, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre)configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 4B by the vertical and horizontal hashing. As shown in FIG. 4B, for sidelink, the physical sidelink control channel (PSCCH) and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user date for the UE. In the example of FIG. 4B, the PSCCH occupies half the bandwidth of the sub-channel and only three symbols. Finally, a gap symbol is present after the PSSCH.

FIG. 4C is a diagram 450 of an example slot structure with feedback resources, according to aspects of the disclosure. In the example of FIG. 4C, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 4C is similar to the slot structure illustrated in FIG. 4A, except that the slot structure illustrated in FIG. 4C includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol after the PSSCH, there is a gap symbol after the two PSFCH symbols. Currently, resources for the PSFCH can be configured with a periodicity selected from the set of {0, 1, 2, 4} slots.

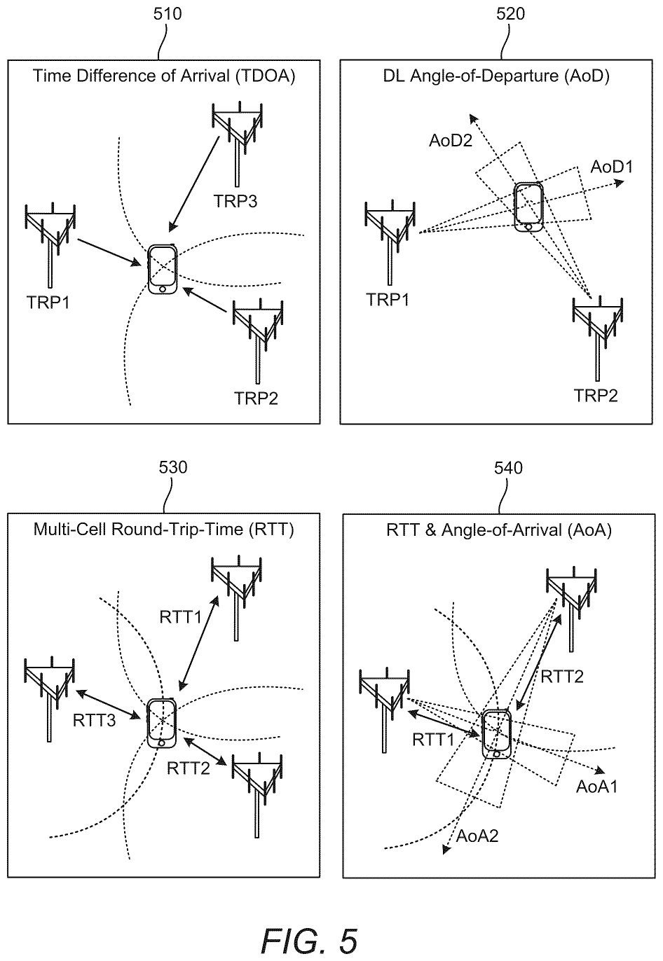

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 5 illustrates examples of various positioning methods, according to aspects of the disclosure. In an OTDOA or DL-TDOA positioning procedure, illustrated by scenario 510, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 520, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 530, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 540.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

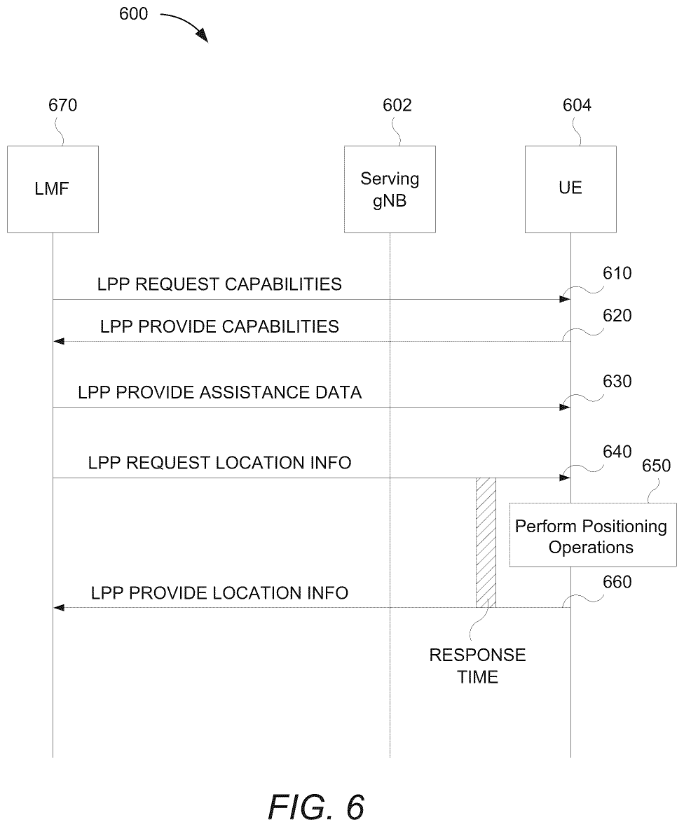

FIG. 6 illustrates an example Long-Term Evolution (LTE) positioning protocol (LPP) procedure 600 between a UE 604 and a location server (illustrated as a location management function (LMF) 670) for performing positioning operations. As illustrated in FIG. 6, positioning of the UE 604 is supported via an exchange of LPP messages between the UE 604 and the LMF 670. The LPP messages may be exchanged between UE 604 and the LMF 670 via the UE's 604 serving base station (illustrated as a serving gNB 602) and a core network (not shown). The LPP procedure 600 may be used to position the UE 604 in order to support various location-related services, such as navigation for UE 604 (or for the user of UE 604), or for routing, or for provision of an accurate location to a public safety answering point (PSAP) in association with an emergency call from UE 604 to a PSAP, or for some other reason. The LPP procedure 600 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 604 may receive a request for its positioning capabilities from the LMF 670 at stage 610 (e.g., an LPP Request Capabilities message). At stage 620, the UE 604 provides its positioning capabilities to the LMF 670 relative to the LPP protocol by sending an LPP Provide Capabilities message to LMF 670 indicating the position methods and features of these position methods that are supported by the UE 604 using LPP. The capabilities indicated in the LPP Provide Capabilities message may, in some aspects, indicate the type of positioning the UE 604 supports (e.g., DL-TDOA, RTT, E-CID, etc.) and may indicate the capabilities of the UE 604 to support those types of positioning.

Upon reception of the LPP Provide Capabilities message, at stage 620, the LMF 670 determines to use a particular type of positioning method (e.g., DL-TDOA, RTT, E-CID, etc.) based on the indicated type(s) of positioning the UE 604 supports and determines a set of one or more transmission-reception points (TRPs) from which the UE 604 is to measure downlink positioning reference signals or towards which the UE 604 is to transmit uplink positioning reference signals. At stage 630, the LMF 670 sends an LPP Provide Assistance Data message to the UE 604 identifying the set of TRPs.

In some implementations, the LPP Provide Assistance Data message at stage 630 may be sent by the LMF 670 to the UE 604 in response to an LPP Request Assistance Data message sent by the UE 604 to the LMF 670 (not shown in FIG. 6). An LPP Request Assistance Data message may include an identifier of the UE's 604 serving TRP and a request for the positioning reference signal (PRS) configuration of neighboring TRPs.

At stage 640, the LMF 670 sends a request for location information to the UE 604. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 630 may be sent after the LPP Request Location Information message at 640 if, for example, the UE 604 sends a request for assistance data to LMF 670 (e.g., in an LPP Request Assistance Data message, not shown in FIG. 6) after receiving the request for location information at stage 640.

At stage 650, the UE 604 utilizes the assistance information received at stage 630 and any additional data (e.g., a desired location accuracy or a maximum response time) received at stage 640 to perform positioning operations (e.g., measurements of DL-PRS, transmission of UL-PRS, etc.) for the selected positioning method.

At stage 660, the UE 604 may send an LPP Provide Location Information message to the LMF 670 conveying the results of any measurements that were obtained at stage 650 (e.g., time of arrival (ToA), reference signal time difference (RSTD), reception-to-transmission (Rx-Tx), etc.) and before or when any maximum response time has expired (e.g., a maximum response time provided by the LMF 670 at stage 640). The LPP Provide Location Information message at stage 660 may also include the time (or times) at which the positioning measurements were obtained and the identity of the TRP(s) from which the positioning measurements were obtained. Note that the time between the request for location information at 640 and the response at 660 is the “response time” and indicates the latency of the positioning session.

The LMF 670 computes an estimated location of the UE 604 using the appropriate positioning techniques (e.g., DL-TDOA, RTT, E-CID, etc.) based, at least in part, on measurements received in the LPP Provide Location Information message at stage 660.

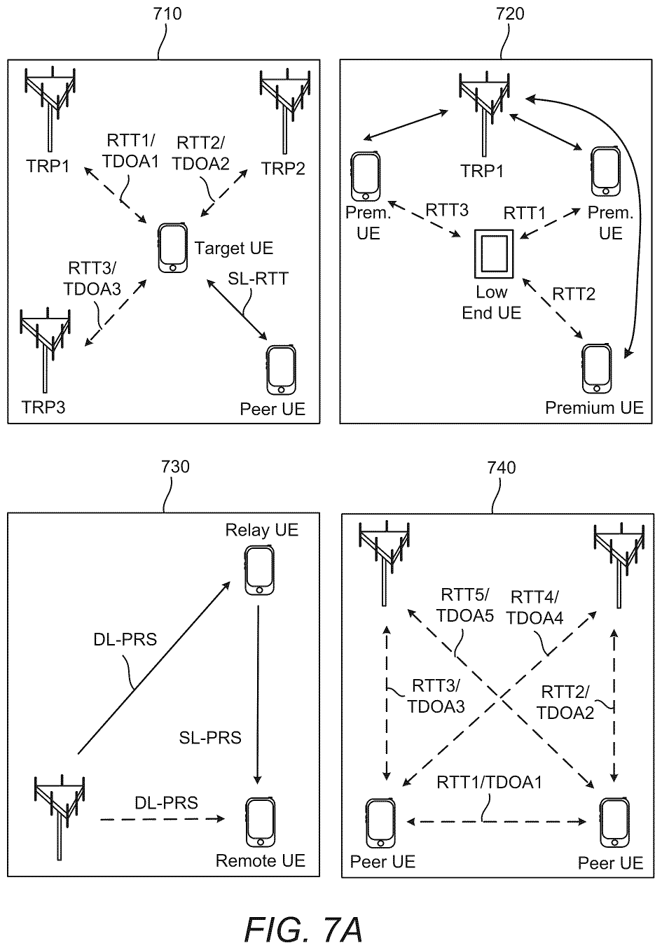

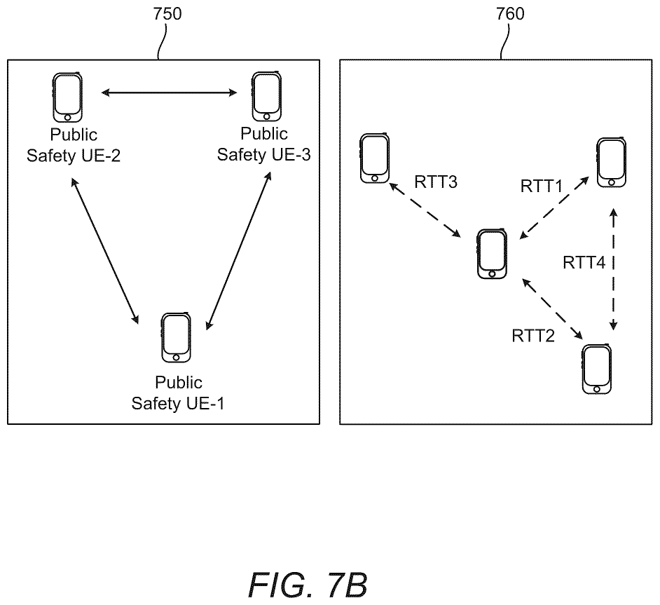

NR supports, or enables, various sidelink positioning techniques. FIG. 7A illustrates various scenarios of interest for sidelink-only or joint Uu and sidelink positioning, according to aspects of the disclosure. In scenario 710, at least one peer UE with a known location can improve the Uu-based positioning (e.g., multi-cell round-trip-time (RTT), downlink time difference of arrival (DL-TDOA), etc.) of a target UE by providing an additional anchor (e.g., using sidelink RTT (SL-RTT)). In scenario 720, a low-end (e.g., reduced capacity, or “RedCap”) target UE may obtain the assistance of premium UEs to determine its location using, e.g., sidelink positioning and ranging procedures with the premium UEs. Compared to the low-end UE, the premium UEs may have more capabilities, such as more sensors, a faster processor, more memory, more antenna elements, higher transmit power capability, access to additional frequency bands, or any combination thereof. In scenario 730, a relay UE (e.g., with a known location) participates in the positioning estimation of a remote UE without performing uplink positioning reference signal (PRS) transmission over the Uu interface. Scenario 740 illustrates the joint positioning of multiple UEs. Specifically, in scenario 740, two UEs with unknown positions can be jointly located in non-line-of-sight (NLOS) conditions by utilizing constraints from nearby UEs.

FIG. 7B illustrates additional scenarios of interest for sidelink-only or joint Uu and sidelink positioning, according to aspects of the disclosure. In scenario 750, UEs used for public safety (e.g., by police, firefighters, and/or the like) may perform peer-to-peer (P2P) positioning and ranging for public safety and other uses. For example, in scenario 750, the public safety UEs may be out of coverage of a network and determine a location or a relative distance and a relative position among the public safety UEs using sidelink positioning techniques. Similarly, scenario 760 shows multiple UEs that are out of coverage and determine a location or a relative distance and a relative position using sidelink positioning techniques, such as SL-RTT.

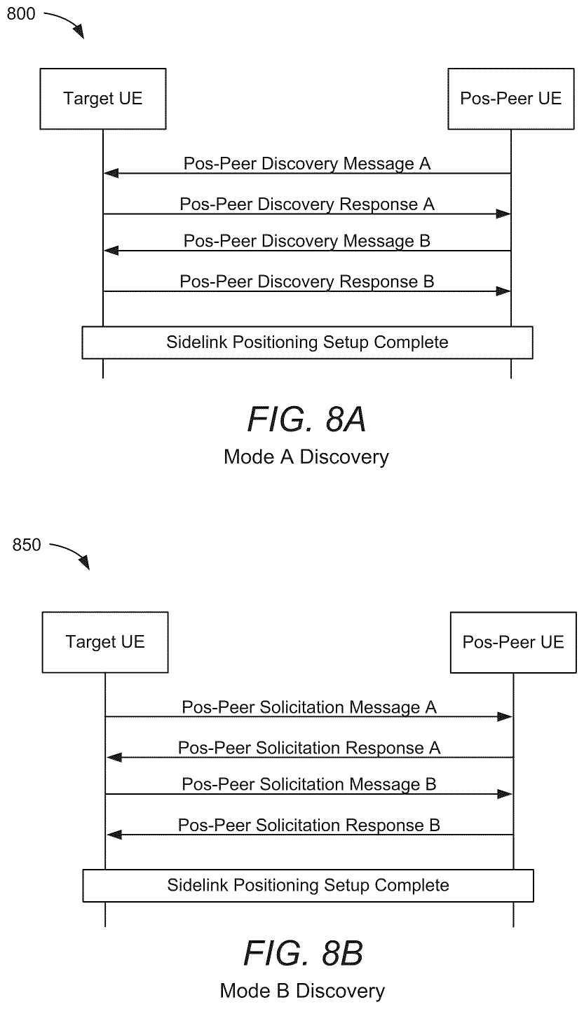

A UE that assists a target UE in a positioning procedure may be referred to as a “positioning peer” or “Pos-Peer” UE. Two types of Pos-Peer UE discovery procedures have been introduced for sidelink cooperative positioning (e.g., the sidelink-based positioning procedure in FIG. 7), referred to as Mode A and Mode B. FIG. 8A illustrates an example call flow 800 for Mode A discovery, and FIG. 8B illustrates an example call flow 850 for Mode B discovery, according to aspects of the disclosure. The purpose of these discovery procedures is to discover which Pos-Peer UEs are in the vicinity of a target UE. In Mode A, a Pos-Peer UE may announce its presence by broadcasting a sidelink Pos-Peer discovery message with a positioning flag, as shown in FIG. 8A. In Mode B, a target UE that wants to discover Pos-Peer UEs may initiate by broadcasting a sidelink Pos-Peer solicitation message with field(s) related to positioning, as shown in FIG. 8B.

As shown in FIGS. 8A and 8B, both Pos-Peer discovery and solicitation messages can be split into two parts, labeled “A” and “B,” to enable a more power efficient approach and a handshake between the target UE and the potential Pos-Peer UEs. A target UE can rank the potential Pos-Peer UEs (also referred to as anchor UEs) according to the following criteria: (1) location quality criterion, (2) channel quality criterion, (3) response time criterion, (4) mobility state criterion, or any combination thereof.

As shown in various scenarios in FIGS. 7A and 7B, multiple UEs may be connected to each other through sidelink. These UEs may form a sidelink positioning group. There are various V2X properties, or parameters, that may be associated with a UE in a sidelink positioning group or the sidelink positioning group itself, such as the density (i.e., number) of the UEs in the group (e.g., low, medium, or high), the average speed of the UE (which can vary over time), the terrain over which the UE is traveling (e.g., high altitude, flat, etc.), whether the UE is moving on a straight highway path or a more frequent turning path, and/or the source and destination addresses selected by the UE or the path of motion taken by the UE.

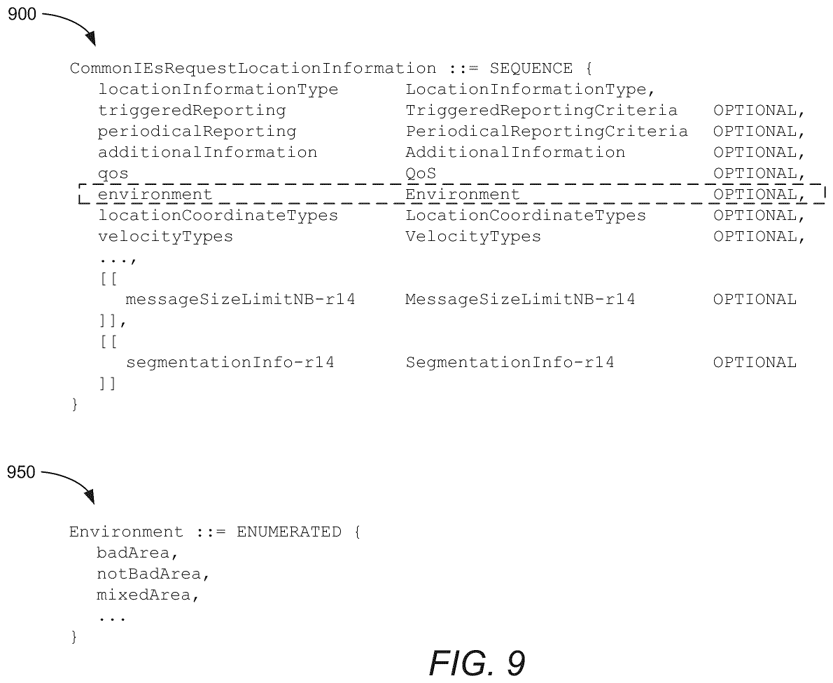

FIG. 9 illustrates existing LPP information elements (IEs) that can be used to provide information about a UE's environment, according to aspects of the disclosure. A “CommonIEsRequestLocationInformation” IE 900 may be included in an LPP Request Location Information message, as at stage 640, and includes an “Environment” field that points to an “environment” IE 950. An “environment” IE 950 provides the target UE with information about expected multipath and non-line-of-sight (NLOS) in the current area. Currently, only the following values are defined: (1) “badArea,” meaning possibly heavy multipath and NLOS conditions (e.g. bad urban or urban), (2) “notBadArea,” meaning no or light multipath and usually LOS conditions (e.g. suburban or rural), and (3) “mixedArea,” meaning an environment that is mixed or not defined. If the Environment field is absent, a default value of “mixedArea” is applied.

As shown, the current LPP “environment” IE 950 does not include any fields for reporting V2X sidelink parameters (e.g., density, average speed, terrain, etc.). Accordingly, the present disclosure provides for “environment” signaling related to sidelink positioning within an LPP Location Request and/or LPP Location Response message between a UE and a location server, or within a sidelink discovery request and/or discovery response between two UEs (over the PC5 interface). These messages may include one or more of the following parameters: (1) UE Density, (2) UE Mobility, (3) UE Acceleration, (4) Terrain Type, and/or (5) Expected Path.

The UE Density parameter indicates the density of Pos-Peer UEs within the sidelink positioning group observed by the UE sending the location request or the UE sending the location response (depending on which UE has been requested to report the parameter). This parameter may have a value of “low,” “medium,” “high,” or “unknown,” where each value corresponds to a range of values. For example, the value of “low” may correspond to five or fewer Pos-Peer UEs. Alternatively, this parameter may be defined with a specific integer value (e.g., X UEs within a radius of Y meters).

The UE Mobility parameter indicates the average, minimum, median, and/or maximum speed of the UEs within the sidelink positioning group observed by the UE sending the location request or the UE sending the location response (depending on which UE has been requested to report the parameter).

The UE Acceleration parameter indicates whether the UE is engaged in a frequent start and stop scenario (e.g., as in heavy traffic or city driving) where the UE's motion is expected to change frequently, or whether the UE is driving at a relatively constant speed (e.g., on a highway). For example, this parameter may indicate a frequency with which the UEs within the sidelink positioning group observed by the UE change acceleration more than a threshold.

The Terrain Type parameter indicates the type of terrain over which the UE is traveling or is expected to travel. More specifically, this parameter therefore provides information about the vertical displacement the UE is expected to experience (e.g., flat, hilly, etc.). This parameter also provides information about the expected horizontal displacement the UE is expected to experience (e.g., straight, curved, etc.). This parameter may therefore indicate whether the UE is moving along a straight highway path or a more frequently turning path.

The Expected Path parameter indicates the source and destination addresses selected by the UE. Alternatively, this parameter may indicate the path of motion taken by the UE over some period of time.

Each UE in a sidelink positioning group may provide the above parameters to each other, to a target UE within the group, or to a location server. Alternatively, a location server may collect these parameters from all (or some set of) Pos-Peer UEs within a sidelink communication group or all UEs within the group and then provide the information to a target UE within the group.

There are several options regarding how a UE may receive the above parameters. As a first option, the location server may provide theses environment parameters to a target UE (e.g., a UE being positioned) or to all of the UEs in the sidelink positioning group. For example, the location server may provide these parameters in an LPP Request Location Information message, as at stage 640.

As a second option, a UE (e.g., a target UE or a Pos-Peer UE) may report these environment parameters to a location server, a target UE (where the reporting UE is a Pos-Peer UE), a Pos-Peer UE (where the reporting UE is the target UE), or all UEs in the sidelink positioning group. This reporting may be part of a discovery phase request (e.g., a Pos-Peer Discovery Message in FIG. 8A or a Pos-Peer Solicitation Message in FIG. 8B) or a discovery phase response (e.g., a Pos-Peer Discovery Response in FIG. 8A or a Pos-Peer Solicitation Response in FIG. 8B).

A target UE can use this information to decide whether to initiate a sidelink positioning session with a specific Pos-Peer UE (e.g., note that the Pos-Peer UE may be an RSU or another UE). The target UE may also use this information to decide what type of sidelink positioning reference signal transmission parameters to use, such as periodicity, response time, transmit power, etc. A UE in the sidelink positioning group (whether a target UE or Pos-Peer UE) may also or alternatively use this information to decide which type of vehicle vision to use (e.g., radar, lidar, and/or camera). A UE in the sidelink positioning group (whether a target UE or Pos-Peer UE) may also or alternatively use this information to select a type of positioning method to use.

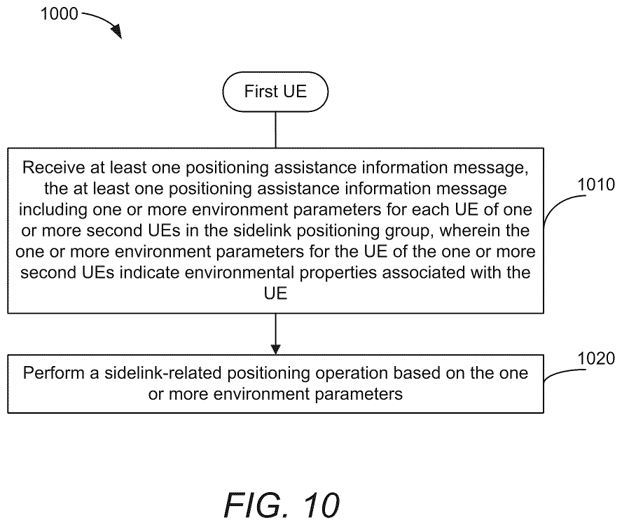

FIG. 10 illustrates an example method 1000 of wireless communication, according to aspects of the disclosure. In an aspect, method 1000 may be performed by a first UE in a sidelink positioning group (e.g., any of the UEs described herein).

At 1010, the first UE receives at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE. In an aspect, operation 1010 may be performed by the one or more WWAN transceivers 310, the one or more processors 332, memory 340, and/or positioning component 342, any or all of which may be considered means for performing this operation.

At 1020, the first UE performs a sidelink-related positioning operation based on the one or more environment parameters. In an aspect, operation 1020 may be performed by the one or more WWAN transceivers 310, the one or more processors 332, memory 340, and/or positioning component 342, any or all of which may be considered means for performing this operation.

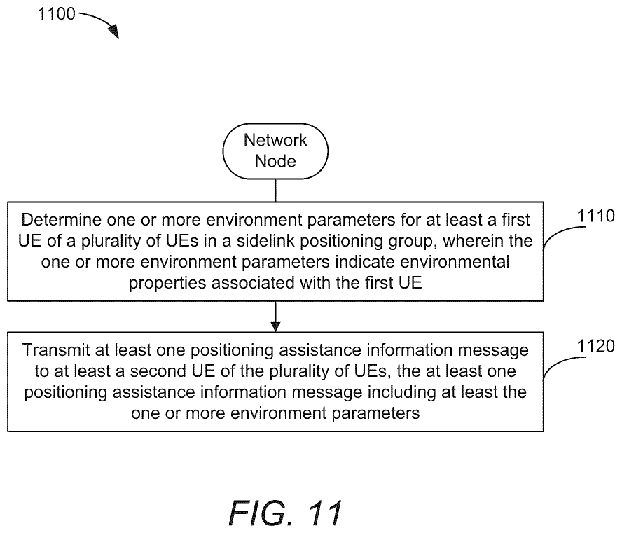

FIG. 11 illustrates an example method 1200 of wireless communication, according to aspects of the disclosure. In an aspect, method 1200 may be performed by a network node (e.g., a location server or any of the UEs described herein).

At 1110, the network node determines one or more environment parameters for at least a first UE of a plurality of UEs in a sidelink positioning group, wherein the one or more environment parameters indicate environmental properties associated with the first UE. In an aspect, where the network node is a UE, operation 1110 may be performed by the one or more WWAN transceivers 310, the one or more processors 332, memory 340, and/or positioning component 342, any or all of which may be considered means for performing this operation. In an aspect, where the network node is a location server or other network entity, operation 1110 may be performed by the one or more network transceivers 390, the one or more processors 394, memory 396, and/or positioning component 398, any or all of which may be considered means for performing this operation.

At 1120, the network node transmits at least one positioning assistance information message to at least a second UE of the plurality of UEs, the at least one positioning assistance information message including at least the one or more environment parameters. In an aspect, where the network node is a UE, operation 1110 may be performed by the one or more WWAN transceivers 310, the one or more processors 332, memory 340, and/or positioning component 342, any or all of which may be considered means for performing this operation. In an aspect, where the network node is a location server or other network entity, operation 1110 may be performed by the one or more network transceivers 390, the one or more processors 394, memory 396, and/or positioning component 398, any or all of which may be considered means for performing this operation.

As will be appreciated, a technical advantage of the methods 1000 and 1100 is improved sidelink operations due to having access to more environmental information.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a first user equipment (UE) in a sidelink positioning group, comprising: receiving at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and performing a sidelink-related positioning operation based on the one or more environment parameters.

Clause 2. The method of clause 1, wherein the one or more environment parameters include: a UE density parameter indicating a number of UEs within the sidelink positioning group observed by the UE, a UE mobility parameter indicating a speed of the UEs within the sidelink positioning group observed by the UE, a UE acceleration parameter indicating a frequency with which the UEs within the sidelink positioning group observed by the UE change acceleration more than a threshold, a terrain type parameter indicating a type of terrain observed by the UE, an expected path parameter indicating a source address, a destination address, or both selected by the UE, or a path of motion of the UE, or any combination thereof.

Clause 3. The method of clause 2, wherein the UE density parameter has a value of: low, medium, high, or the number of the UEs within the sidelink positioning group.

Clause 4. The method of any of clauses 2 to 3, wherein the speed of the UEs within the sidelink positioning group comprises: an average speed, a median speed, a minimum speed, a maximum speed, or any combination thereof.

Clause 5. The method of any of clauses 2 to 4, wherein the terrain type parameter indicating the type of terrain observed by the UE indicates an expected vertical displacement, horizontal displacement, or both.

Clause 6. The method of any of clauses 1 to 5, wherein the at least one positioning assistance information message is received from a location server.

Clause 7. The method of clause 6, wherein the at least one positioning assistance information message comprises or is included in one or more Long-Term Evolution (LTE) positioning procedure (LPP) messages.

Clause 8. The method of any of clauses 1 to 5, wherein: the one or more second UEs comprise a plurality of second UEs, the at least one positioning assistance information message comprises a plurality of positioning assistance information messages, reception of the at least one positioning assistance information message comprises reception of the plurality of positioning assistance information messages, and each positioning assistance information message of the plurality of positioning assistance information messages is received from one of the plurality of second UEs.

Clause 9. The method of clause 8, wherein the at least one positioning assistance information message is received in: a sidelink discovery request message, a sidelink discovery response message, a sidelink positioning request message, or a sidelink positioning response message.

Clause 10. The method of any of clauses 1 to 9, wherein performing the sidelink-related positioning operation comprises: initiating a sidelink positioning session with at least one UE of the one or more second UEs based on the one or more environment parameters; determining a type of positioning method for the sidelink positioning session based on the one or more environment parameters; determining transmission parameters for sidelink positioning reference signals based on the one or more environment parameters; determining a type of vehicle vision to use based on the one or more environment parameters; or any combination thereof.

Clause 11. A method of wireless communication performed by a network node, comprising: determining one or more environment parameters for at least a first UE of a plurality of UEs in a sidelink positioning group, wherein the one or more environment parameters indicate environmental properties associated with the first UE; and transmitting at least one positioning assistance information message to at least a second UE of the plurality of UEs, the at least one positioning assistance information message including at least the one or more environment parameters.

Clause 12. The method of clause 11, wherein the one or more environment parameters include: a UE density parameter indicating a number of UEs within the sidelink positioning group observed by the first UE, a UE mobility parameter indicating a speed of the UEs within the sidelink positioning group observed by the first UE, a UE acceleration parameter indicating a frequency with which the UEs within the sidelink positioning group observed by the first UE change acceleration more than a threshold, a terrain type parameter indicating a type of terrain observed by the first UE, an expected path parameter indicating a source address, a destination address, or both selected by the first UE, or a path of motion of the first UE, or any combination thereof.

Clause 13. The method of clause 12, wherein the UE density parameter has a value of: low, medium, high, or the number of the UEs within the sidelink positioning group.

Clause 14. The method of any of clauses 12 to 13, wherein the speed of the UEs within the sidelink positioning group comprises: an average speed, a median speed, a minimum speed, a maximum speed, or any combination thereof.

Clause 15. The method of any of clauses 12 to 14, wherein the terrain type parameter indicating the type of terrain observed by the first UE indicates an expected vertical displacement, horizontal displacement, or both.

Clause 16. The method of any of clauses 11 to 15, wherein the network node is a location server.

Clause 17. The method of clause 16, wherein determining the one or more environment parameters comprises: receiving the one or more environment parameters from at least the first UE.

Clause 18. The method of clause 17, wherein receiving the one or more environment parameters comprises: receiving the one or more environment parameters from each of the plurality of UEs.

Clause 19. The method of any of clauses 16 to 18, wherein: the one or more environment parameters are received from the first UE via Long-Term Evolution (LTE) positioning procedure (LPP), and the at least one positioning assistance information message is transmitted to at least the second UE via LPP.

Clause 20. The method of any of clauses 11 to 15, wherein the network node is the first UE.

Clause 21. The method of clause 20, wherein determining the one or more environment parameters comprises: measuring the one or more environment parameters.

Clause 22. The method of any of clauses 20 to 21, wherein the at least one positioning assistance information message is transmitted in: a sidelink discovery request message, a sidelink discovery response message, a sidelink positioning request message, or a sidelink positioning response message.

Clause 23. The method of any of clauses 20 to 22, further comprising: receiving at least one second positioning assistance information message, the at least one second positioning assistance information message including one or more second environment parameters for each UE of the plurality of UEs in the sidelink positioning group other than the first UE.

Clause 24. The method of clause 23, wherein: the at least one second positioning assistance information message comprises a plurality of positioning assistance information messages, reception of the at least one second positioning assistance information message comprises reception of the plurality of positioning assistance information messages, and each positioning assistance information message of the plurality of positioning assistance information messages is received from one of the plurality of second UEs other than the first UE.

Clause 25. A first user equipment (UE), comprising: a memory; at least one transceiver; and at least one processor communicatively coupled to the memory and the at least one transceiver, the at least one processor configured to: receive, via the at least one transceiver, at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and perform a sidelink-related positioning operation based on the one or more environment parameters.

Clause 26. The first UE of clause 25, wherein the one or more environment parameters include: a UE density parameter indicating a number of UEs within the sidelink positioning group observed by the UE, a UE mobility parameter indicating a speed of the UEs within the sidelink positioning group observed by the UE, a UE acceleration parameter indicating a frequency with which the UEs within the sidelink positioning group observed by the UE change acceleration more than a threshold, a terrain type parameter indicating a type of terrain observed by the UE, an expected path parameter indicating a source address, a destination address, or both selected by the UE, or a path of motion of the UE, or any combination thereof.

Clause 27. The first UE of clause 26, wherein the UE density parameter has a value of: low, medium, high, or the number of the UEs within the sidelink positioning group.

Clause 28. The first UE of any of clauses 26 to 27, wherein the speed of the UEs within the sidelink positioning group comprises: an average speed, a median speed, a minimum speed, a maximum speed, or any combination thereof.

Clause 29. The first UE of any of clauses 26 to 28, wherein the terrain type parameter indicating the type of terrain observed by the UE indicates an expected vertical displacement, horizontal displacement, or both.

Clause 30. The first UE of any of clauses 25 to 29, wherein the at least one positioning assistance information message is received from a location server.

Clause 31. The first UE of clause 30, wherein the at least one positioning assistance information message comprises or is included in one or more Long-Term Evolution (LTE) positioning procedure (LPP) messages.

Clause 32. The first UE of any of clauses 25 to 29, wherein: the one or more second UEs comprise a plurality of second UEs, the at least one positioning assistance information message comprises a plurality of positioning assistance information messages, reception of the at least one positioning assistance information message comprises reception of the plurality of positioning assistance information messages, and each positioning assistance information message of the plurality of positioning assistance information messages is received from one of the plurality of second UEs.

Clause 33. The first UE of clause 32, wherein the at least one positioning assistance information message is received in: a sidelink discovery request message, a sidelink discovery response message, a sidelink positioning request message, or a sidelink positioning response message.

Clause 34. The first UE of any of clauses 25 to 33, wherein the at least one processor configured to perform the sidelink-related positioning operation comprises the at least one processor configured to: initiate a sidelink positioning session with at least one UE of the one or more second UEs based on the one or more environment parameters; determine a type of positioning method for the sidelink positioning session based on the one or more environment parameters; determine transmission parameters for sidelink positioning reference signals based on the one or more environment parameters; determine a type of vehicle vision to use based on the one or more environment parameters; or any combination thereof.

Clause 35. A network node, comprising: a memory; at least one transceiver; and at least one processor communicatively coupled to the memory and the at least one transceiver, the at least one processor configured to: determine one or more environment parameters for at least a first UE of a plurality of UEs in a sidelink positioning group, wherein the one or more environment parameters indicate environmental properties associated with the first UE; and transmit, via the at least one transceiver, at least one positioning assistance information message to at least a second UE of the plurality of UEs, the at least one positioning assistance information message including at least the one or more environment parameters.

Clause 36. The network node of clause 35, wherein the one or more environment parameters include: a UE density parameter indicating a number of UEs within the sidelink positioning group observed by the first UE, a UE mobility parameter indicating a speed of the UEs within the sidelink positioning group observed by the first UE, a UE acceleration parameter indicating a frequency with which the UEs within the sidelink positioning group observed by the first UE change acceleration more than a threshold, a terrain type parameter indicating a type of terrain observed by the first UE, an expected path parameter indicating a source address, a destination address, or both selected by the first UE, or a path of motion of the first UE, or any combination thereof.

Clause 37. The network node of clause 36, wherein the UE density parameter has a value of: low, medium, high, or the number of the UEs within the sidelink positioning group.

Clause 38. The network node of any of clauses 36 to 37, wherein the speed of the UEs within the sidelink positioning group comprises: an average speed, a median speed, a minimum speed, a maximum speed, or any combination thereof.

Clause 39. The network node of any of clauses 36 to 38, wherein the terrain type parameter indicating the type of terrain observed by the first UE indicates an expected vertical displacement, horizontal displacement, or both.

Clause 40. The network node of any of clauses 35 to 39, wherein the network node is a location server.

Clause 41. The network node of clause 40, wherein the at least one processor configured to determine the one or more environment parameters comprises the at least one processor configured to: receive, via the at least one transceiver, the one or more environment parameters from at least the first UE.

Clause 42. The network node of clause 41, wherein the at least one processor configured to receive the one or more environment parameters comprises the at least one processor configured to: receive, via the at least one transceiver, the one or more environment parameters from each of the plurality of UEs.

Clause 43. The network node of any of clauses 40 to 42, wherein: the one or more environment parameters are received from the first UE via Long-Term Evolution (LTE) positioning procedure (LPP), and the at least one positioning assistance information message is transmitted to at least the second UE via LPP.

Clause 44. The network node of any of clauses 35 to 39, wherein the network node is the first UE.

Clause 45. The network node of clause 44, wherein the at least one processor configured to determine the one or more environment parameters comprises the at least one processor configured to: measure the one or more environment parameters.

Clause 46. The network node of any of clauses 44 to 45, wherein the at least one positioning assistance information message is transmitted in: a sidelink discovery request message, a sidelink discovery response message, a sidelink positioning request message, or a sidelink positioning response message.

Clause 47. The network node of any of clauses 44 to 46, wherein the at least one processor is further configured to: receive, via the at least one transceiver, at least one second positioning assistance information message, the at least one second positioning assistance information message including one or more second environment parameters for each UE of the plurality of UEs in the sidelink positioning group other than the first UE.

Clause 48. The network node of clause 47, wherein: the at least one second positioning assistance information message comprises a plurality of positioning assistance information messages, reception of the at least one second positioning assistance information message comprises reception of the plurality of positioning assistance information messages, and each positioning assistance information message of the plurality of positioning assistance information messages is received from one of the plurality of second UEs other than the first UE.

Clause 49. A first user equipment (UE), comprising: means for receiving at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and means for performing a sidelink-related positioning operation based on the one or more environment parameters.

Clause 50. The first UE of clause 49, wherein the one or more environment parameters include: a UE density parameter indicating a number of UEs within the sidelink positioning group observed by the UE, a UE mobility parameter indicating a speed of the UEs within the sidelink positioning group observed by the UE, a UE acceleration parameter indicating a frequency with which the UEs within the sidelink positioning group observed by the UE change acceleration more than a threshold, a terrain type parameter indicating a type of terrain observed by the UE, an expected path parameter indicating a source address, a destination address, or both selected by the UE, or a path of motion of the UE, or any combination thereof.

Clause 51. The first UE of clause 50, wherein the UE density parameter has a value of: low, medium, high, or the number of the UEs within the sidelink positioning group.

Clause 52. The first UE of any of clauses 50 to 51, wherein the speed of the UEs within the sidelink positioning group comprises: an average speed, a median speed, a minimum speed, a maximum speed, or any combination thereof.

Clause 53. The first UE of any of clauses 50 to 52, wherein the terrain type parameter indicating the type of terrain observed by the UE indicates an expected vertical displacement, horizontal displacement, or both.

Clause 54. The first UE of any of clauses 49 to 53, wherein the at least one positioning assistance information message is received from a location server.

Clause 55. The first UE of clause 54, wherein the at least one positioning assistance information message comprises or is included in one or more Long-Term Evolution (LTE) positioning procedure (LPP) messages.

Clause 56. The first UE of any of clauses 49 to 53, wherein: the one or more second UEs comprise a plurality of second UEs, the at least one positioning assistance information message comprises a plurality of positioning assistance information messages, reception of the at least one positioning assistance information message comprises reception of the plurality of positioning assistance information messages, and each positioning assistance information message of the plurality of positioning assistance information messages is received from one of the plurality of second UEs.

Clause 57. The first UE of clause 56, wherein the at least one positioning assistance information message is received in: a sidelink discovery request message, a sidelink discovery response message, a sidelink positioning request message, or a sidelink positioning response message.

Clause 58. The first UE of any of clauses 49 to 57, wherein the means for performing the sidelink-related positioning operation comprises: means for initiating a sidelink positioning session with at least one UE of the one or more second UEs based on the one or more environment parameters; means for determining a type of positioning method for the sidelink positioning session based on the one or more environment parameters, means for determining transmission parameters for sidelink positioning reference signals based on the one or more environment parameters; means for determining a type of vehicle vision to use based on the one or more environment parameters; or any combination thereof.

Clause 59. A network node, comprising: means for determining one or more environment parameters for at least a first UE of a plurality of UEs in a sidelink positioning group, wherein the one or more environment parameters indicate environmental properties associated with the first UE; and means for transmitting at least one positioning assistance information message to at least a second UE of the plurality of UEs, the at least one positioning assistance information message including at least the one or more environment parameters.

Clause 60. The network node of clause 59, wherein the one or more environment parameters include: a UE density parameter indicating a number of UEs within the sidelink positioning group observed by the first UE, a UE mobility parameter indicating a speed of the UEs within the sidelink positioning group observed by the first UE, a UE acceleration parameter indicating a frequency with which the UEs within the sidelink positioning group observed by the first UE change acceleration more than a threshold, a terrain type parameter indicating a type of terrain observed by the first UE, an expected path parameter indicating a source address, a destination address, or both selected by the first UE, or a path of motion of the first UE, or any combination thereof.

Clause 61. The network node of clause 60, wherein the UE density parameter has a value of: low, medium, high, or the number of the UEs within the sidelink positioning group.

Clause 62. The network node of any of clauses 60 to 61, wherein the speed of the UEs within the sidelink positioning group comprises: an average speed, a median speed, a minimum speed, a maximum speed, or any combination thereof.

Clause 63. The network node of any of clauses 60 to 62, wherein the terrain type parameter indicating the type of terrain observed by the first UE indicates an expected vertical displacement, horizontal displacement, or both.

Clause 64. The network node of any of clauses 59 to 63, wherein the network node is a location server.

Clause 65. The network node of clause 64, wherein the means for determining the one or more environment parameters comprises: means for receiving the one or more environment parameters from at least the first UE.

Clause 66. The network node of clause 65, wherein the means for receiving the one or more environment parameters comprises: means for receiving the one or more environment parameters from each of the plurality of UEs.

Clause 67. The network node of any of clauses 64 to 66, wherein: the one or more environment parameters are received from the first UE via Long-Term Evolution (LTE) positioning procedure (LPP), and the at least one positioning assistance information message is transmitted to at least the second UE via LPP.

Clause 68. The network node of any of clauses 59 to 63, wherein the network node is the first UE.

Clause 69. The network node of clause 68, wherein the means for determining the one or more environment parameters comprises: means for measuring the one or more environment parameters.

Clause 70. The network node of any of clauses 68 to 69, wherein the at least one positioning assistance information message is transmitted in: a sidelink discovery request message, a sidelink discovery response message, a sidelink positioning request message, or a sidelink positioning response message.

Clause 71. The network node of any of clauses 68 to 70, further comprising: means for receiving at least one second positioning assistance information message, the at least one second positioning assistance information message including one or more second environment parameters for each UE of the plurality of UEs in the sidelink positioning group other than the first UE.

Clause 72. The network node of clause 71, wherein: the at least one second positioning assistance information message comprises a plurality of positioning assistance information messages, reception of the at least one second positioning assistance information message comprises reception of the plurality of positioning assistance information messages, and each positioning assistance information message of the plurality of positioning assistance information messages is received from one of the plurality of second UEs other than the first UE.

Clause 73. A non-transitory computer-readable medium storing computer-executable instructions that, when executed by a first user equipment (UE), cause the UE to: receive at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and perform a sidelink-related positioning operation based on the one or more environment parameters.

Clause 74. The non-transitory computer-readable medium of clause 73, wherein the one or more environment parameters include: a UE density parameter indicating a number of UEs within the sidelink positioning group observed by the UE, a UE mobility parameter indicating a speed of the UEs within the sidelink positioning group observed by the UE, a UE acceleration parameter indicating a frequency with which the UEs within the sidelink positioning group observed by the UE change acceleration more than a threshold, a terrain type parameter indicating a type of terrain observed by the UE, an expected path parameter indicating a source address, a destination address, or both selected by the UE, or a path of motion of the UE, or any combination thereof.

Clause 75. The non-transitory computer-readable medium of clause 74, wherein the UE density parameter has a value of: low, medium, high, or the number of the UEs within the sidelink positioning group.

Clause 76. The non-transitory computer-readable medium of any of clauses 74 to 75, wherein the speed of the UEs within the sidelink positioning group comprises: an average speed, a median speed, a minimum speed, a maximum speed, or any combination thereof.

Clause 77. The non-transitory computer-readable medium of any of clauses 74 to 76, wherein the terrain type parameter indicating the type of terrain observed by the UE indicates an expected vertical displacement, horizontal displacement, or both.

Clause 78. The non-transitory computer-readable medium of any of clauses 73 to 77, wherein the at least one positioning assistance information message is received from a location server.

Clause 79. The non-transitory computer-readable medium of clause 78, wherein the at least one positioning assistance information message comprises or is included in one or more Long-Term Evolution (LTE) positioning procedure (LPP) messages.

Clause 80. The non-transitory computer-readable medium of any of clauses 73 to 77, wherein: the one or more second UEs comprise a plurality of second UEs, the at least one positioning assistance information message comprises a plurality of positioning assistance information messages, reception of the at least one positioning assistance information message comprises reception of the plurality of positioning assistance information messages, and each positioning assistance information message of the plurality of positioning assistance information messages is received from one of the plurality of second UEs.

Clause 81. The non-transitory computer-readable medium of clause 80, wherein the at least one positioning assistance information message is received in: a sidelink discovery request message, a sidelink discovery response message, a sidelink positioning request message, or a sidelink positioning response message.

Clause 82. The non-transitory computer-readable medium of any of clauses 73 to 81, wherein the computer-executable instructions that, when executed by the UE, cause the UE to perform the sidelink-related positioning operation comprise computer-executable instructions that, when executed by the UE, cause the UE to: initiate a sidelink positioning session with at least one UE of the one or more second UEs based on the one or more environment parameters; determine a type of positioning method for the sidelink positioning session based on the one or more environment parameters; determine transmission parameters for sidelink positioning reference signals based on the one or more environment parameters; determine a type of vehicle vision to use based on the one or more environment parameters; or any combination thereof.

Clause 83. A non-transitory computer-readable medium storing computer-executable instructions that, when executed by a network node, cause the network node to: determine one or more environment parameters for at least a first UE of a plurality of UEs in a sidelink positioning group, wherein the one or more environment parameters indicate environmental properties associated with the first UE; and transmit at least one positioning assistance information message to at least a second UE of the plurality of UEs, the at least one positioning assistance information message including at least the one or more environment parameters.

Clause 84. The non-transitory computer-readable medium of clause 83, wherein the one or more environment parameters include: a UE density parameter indicating a number of UEs within the sidelink positioning group observed by the first UE, a UE mobility parameter indicating a speed of the UEs within the sidelink positioning group observed by the first UE, a UE acceleration parameter indicating a frequency with which the UEs within the sidelink positioning group observed by the first UE change acceleration more than a threshold, a terrain type parameter indicating a type of terrain observed by the first UE, an expected path parameter indicating a source address, a destination address, or both selected by the first UE, or a path of motion of the first UE, or any combination thereof.

Clause 85. The non-transitory computer-readable medium of clause 84, wherein the UE density parameter has a value of: low, medium, high, or the number of the UEs within the sidelink positioning group.

Clause 86. The non-transitory computer-readable medium of any of clauses 84 to 85, wherein the speed of the UEs within the sidelink positioning group comprises: an average speed, a median speed, a minimum speed, a maximum speed, or any combination thereof.

Clause 87. The non-transitory computer-readable medium of any of clauses 84 to 86, wherein the terrain type parameter indicating the type of terrain observed by the first UE indicates an expected vertical displacement, horizontal displacement, or both.

Clause 88. The non-transitory computer-readable medium of any of clauses 83 to 87, wherein the network node is a location server.

Clause 89. The non-transitory computer-readable medium of clause 88, wherein the computer-executable instructions that, when executed by the network node, cause the network node to determine the one or more environment parameters comprise computer-executable instructions that, when executed by the network node, cause the network node to: receive the one or more environment parameters from at least the first UE.

Clause 90. The non-transitory computer-readable medium of clause 89, wherein the computer-executable instructions that, when executed by the network node, cause the network node to receive the one or more environment parameters comprise computer-executable instructions that, when executed by the network node, cause the network node to: receive the one or more environment parameters from each of the plurality of UEs.

Clause 91. The non-transitory computer-readable medium of any of clauses 88 to 90, wherein: the one or more environment parameters are received from the first UE via Long-Term Evolution (LTE) positioning procedure (LPP), and the at least one positioning assistance information message is transmitted to at least the second UE via LPP.

Clause 92. The non-transitory computer-readable medium of any of clauses 83 to 87, wherein the network node is the first UE.

Clause 93. The non-transitory computer-readable medium of clause 92, wherein the computer-executable instructions that, when executed by the network node, cause the network node to determine the one or more environment parameters comprise computer-executable instructions that, when executed by the network node, cause the network node to: measure the one or more environment parameters.

Clause 94. The non-transitory computer-readable medium of any of clauses 92 to 93, wherein the at least one positioning assistance information message is transmitted in: a sidelink discovery request message, a sidelink discovery response message, a sidelink positioning request message, or a sidelink positioning response message.

Clause 95. The non-transitory computer-readable medium of any of clauses 92 to 94, further comprising computer-executable instructions that, when executed by the network node, cause the network node to: receive at least one second positioning assistance information message, the at least one second positioning assistance information message including one or more second environment parameters for each UE of the plurality of UEs in the sidelink positioning group other than the first UE.

Clause 96. The non-transitory computer-readable medium of clause 95, wherein: the at least one second positioning assistance information message comprises a plurality of positioning assistance information messages, reception of the at least one second positioning assistance information message comprises reception of the plurality of positioning assistance information messages, and each positioning assistance information message of the plurality of positioning assistance information messages is received from one of the plurality of second UEs other than the first UE.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a first user equipment (UE) in a sidelink positioning group, comprising:
receiving at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and
performing a sidelink-related positioning operation based on the one or more environment parameters.

2. The method of claim 1, wherein the one or more environment parameters include:
a UE density parameter indicating a number of UEs within the sidelink positioning group observed by the UE,
a UE mobility parameter indicating a speed of the UEs within the sidelink positioning group observed by the UE,
a UE acceleration parameter indicating a frequency with which the UEs within the sidelink positioning group observed by the UE change acceleration more than a threshold,
a terrain type parameter indicating a type of terrain observed by the UE,
an expected path parameter indicating a source address, a destination address, or both selected by the UE, or a path of motion of the UE, or
any combination thereof.

3. The method of claim 2, wherein the UE density parameter has a value of:
low,
medium,
high, or
the number of the UEs within the sidelink positioning group.

4. The method of claim 2, wherein the speed of the UEs within the sidelink positioning group comprises:
an average speed,
a median speed,
a minimum speed,
a maximum speed, or
any combination thereof.

5. The method of claim 2, wherein the terrain type parameter indicating the type of terrain observed by the UE indicates an expected vertical displacement, horizontal displacement, or both.

6. The method of claim 1, wherein the at least one positioning assistance information message is received from a location server.

7. The method of claim 6, wherein the at least one positioning assistance information message comprises or is included in one or more Long-Term Evolution (LTE) positioning procedure (LPP) messages.

8. The method of claim 1, wherein:
the one or more second UEs comprise a plurality of second UEs,
the at least one positioning assistance information message comprises a plurality of positioning assistance information messages,
reception of the at least one positioning assistance information message comprises reception of the plurality of positioning assistance information messages, and
each positioning assistance information message of the plurality of positioning assistance information messages is received from one of the plurality of second UEs.

9. The method of claim 8, wherein the at least one positioning assistance information message is received in:
a sidelink discovery request message,
a sidelink discovery response message,
a sidelink positioning request message, or
a sidelink positioning response message.

10. The method of claim 1, wherein performing the sidelink-related positioning operation comprises:
initiating a sidelink positioning session with at least one UE of the one or more second UEs based on the one or more environment parameters;
determining a type of positioning method for the sidelink positioning session based on the one or more environment parameters;
determining transmission parameters for sidelink positioning reference signals based on the one or more environment parameters;
determining a type of vehicle vision to use based on the one or more environment parameters; or
any combination thereof.

11. A method of wireless communication performed by a network node, comprising:
determining one or more environment parameters for at least a first UE of a plurality of UEs in a sidelink positioning group, wherein the one or more environment parameters indicate environmental properties associated with the first UE; and
transmitting at least one positioning assistance information message to at least a second UE of the plurality of UEs, the at least one positioning assistance information message including at least the one or more environment parameters.

12. The method of claim 11, wherein the one or more environment parameters include:
a UE density parameter indicating a number of UEs within the sidelink positioning group observed by the first UE,
a UE mobility parameter indicating a speed of the UEs within the sidelink positioning group observed by the first UE,
a UE acceleration parameter indicating a frequency with which the UEs within the sidelink positioning group observed by the first UE change acceleration more than a threshold,
a terrain type parameter indicating a type of terrain observed by the first UE,
an expected path parameter indicating a source address, a destination address, or both selected by the first UE, or a path of motion of the first UE, or
any combination thereof.

13. The method of claim 12, wherein the UE density parameter has a value of:
low,
medium,
high, or
the number of the UEs within the sidelink positioning group.

14. The method of claim 12, wherein the speed of the UEs within the sidelink positioning group comprises:
an average speed,
a median speed,
a minimum speed,
a maximum speed, or
any combination thereof.

15. The method of claim 12, wherein the terrain type parameter indicating the type of terrain observed by the first UE indicates an expected vertical displacement, horizontal displacement, or both.

16. The method of claim 11, wherein the network node is a location server.

17. The method of claim 16, wherein determining the one or more environment parameters comprises:
receiving the one or more environment parameters from at least the first UE.

18. The method of claim 17, wherein receiving the one or more environment parameters comprises:
receiving the one or more environment parameters from each of the plurality of UEs.

19. The method of claim 16, wherein:
the one or more environment parameters are received from the first UE via Long-Term Evolution (LTE) positioning procedure (LPP), and
the at least one positioning assistance information message is transmitted to at least the second UE via LPP.

20. The method of claim 11, wherein the network node is the first UE.

21. The method of claim 20, wherein determining the one or more environment parameters comprises:
measuring the one or more environment parameters.

22. The method of claim 20, wherein the at least one positioning assistance information message is transmitted in:
a sidelink discovery request message,
a sidelink discovery response message,
a sidelink positioning request message, or
a sidelink positioning response message.

23. The method of claim 20, further comprising:
receiving at least one second positioning assistance information message, the at least one second positioning assistance information message including one or more second environment parameters for each UE of the plurality of UEs in the sidelink positioning group other than the first UE.

24. The method of claim 23, wherein:
the at least one second positioning assistance information message comprises a plurality of positioning assistance information messages,
reception of the at least one second positioning assistance information message comprises reception of the plurality of positioning assistance information messages, and
each positioning assistance information message of the plurality of positioning assistance information messages is received from one of the plurality of second UEs other than the first UE.

25. A first user equipment (UE), comprising:
a memory;
at least one transceiver; and
at least one processor communicatively coupled to the memory and the at least one transceiver, the at least one processor configured to:
receive, via the at least one transceiver, at least one positioning assistance information message, the at least one positioning assistance information message including one or more environment parameters for each UE of one or more second UEs in the sidelink positioning group, wherein the one or more environment parameters for the UE of the one or more second UEs indicate environmental properties associated with the UE; and
perform a sidelink-related positioning operation based on the one or more environment parameters.

26. The first UE of claim 25, wherein the one or more environment parameters include:
a UE density parameter indicating a number of UEs within the sidelink positioning group observed by the UE,
a UE mobility parameter indicating a speed of the UEs within the sidelink positioning group observed by the UE,
a UE acceleration parameter indicating a frequency with which the UEs within the sidelink positioning group observed by the UE change acceleration more than a threshold,
a terrain type parameter indicating a type of terrain observed by the UE,
an expected path parameter indicating a source address, a destination address, or both selected by the UE, or a path of motion of the UE, or
any combination thereof.

27. The first UE of claim 25, wherein the at least one positioning assistance information message is received from a location server.

28. The first UE of claim 25, wherein:
the one or more second UEs comprise a plurality of second UEs,
the at least one positioning assistance information message comprises a plurality of positioning assistance information messages,
reception of the at least one positioning assistance information message comprises reception of the plurality of positioning assistance information messages, and
each positioning assistance information message of the plurality of positioning assistance information messages is received from one of the plurality of second UEs.

29. The first UE of claim 25, wherein the at least one processor configured to perform the sidelink-related positioning operation comprises the at least one processor configured to:
initiate a sidelink positioning session with at least one UE of the one or more second UEs based on the one or more environment parameters;
determine a type of positioning method for the sidelink positioning session based on the one or more environment parameters;
determine transmission parameters for sidelink positioning reference signals based on the one or more environment parameters;
determine a type of vehicle vision to use based on the one or more environment parameters; or
any combination thereof.

30. A network node, comprising:
a memory;
at least one transceiver; and
at least one processor communicatively coupled to the memory and the at least one transceiver, the at least one processor configured to:
determine one or more environment parameters for at least a first UE of a plurality of UEs in a sidelink positioning group, wherein the one or more environment parameters indicate environmental properties associated with the first UE; and
transmit, via the at least one transceiver, at least one positioning assistance information message to at least a second UE of the plurality of UEs, the at least one positioning assistance information message including at least the one or more environment parameters.
